(19) United States
(12) Patent Application Publication
(10) Pub. No.: US 2020/0377351 A1
(43) Pub. Date: Dec. 3, 2020

(54) VEHICLE-MOUNTED DEVICE, CARGO HANDLING MACHINE, CONTROL CIRCUIT, CONTROL METHOD, AND PROGRAM THEREOF

(71) Applicant: NEC CORPORATION, Tokyo (JP)

(72) Inventors: Jun UCHIMURA, Tokyo (JP); Hideaki TAKAHASHI, Tokyo (JP)

(73) Assignee: NEC CORPORATION, Tokyo (JP)

(21) Appl. No.: 16/491,942

(22) PCT Filed: Mar. 1, 2018
(86) PCT No.: PCT/JP2018/007670

§ 371 Date: Sep. 6, 2019

(30) Foreign Application Priority Data
Mar. 22, 2017 (JP) 2017-056011

(51) Int. Cl. B66F 9/075; B66F 9/24

(52) U.S. Cl. CPC B66F 9/0755; B66F 17/003; B66F 9/24

(57) ABSTRACT

A vehicle-mounted device includes an analysis unit and a control unit. The analysis unit detects an insertion target into which an insertion blade is inserted, on the basis of sensing information acquired from a spatial recognition device. The control unit performs a misalignment determination to determine whether or not a positional relationship between an insertion portion of the insertion target and the insertion blade is aligned on the basis of the sensing information.

### TECHNICAL FIELD

The present invention relates to a vehicle-mounted device, a cargo handling machine, a control circuit, a control method, and a program thereof.

### BACKGROUND ART

In recent years, with the development of automatic driving technology and robot technology, the accuracy of spatial recognition technology utilizing a laser or a radar has been improved, and the price of spatial recognition sensors has reduced. On the other hand, a device that manages cargo handling work is used in a cargo handling machine such as a forklift

For example, Patent Document 1 describes detecting that a distance to a container has reached a predetermined value, and an operator is notified that the detected distance has reached the predetermined value.

For example, Patent Document 2 describes calculating an amount of horizontal and vertical misalignments between forks and a cargo handling target from a position on a screen of a mark imaged by a camera, and performing fork automatic alignment control to automatically align the forks with the cargo handling target to eliminate the amount of misalignment.

### DOCUMENTS OF THE PRIOR ART

### Patent Document

[Patent Document 1] Japanese Unexamined Patent Application, First Publication No. 2000-335896

[Patent Document 2] Japanese Unexamined Patent Application, First Publication No. 2003-128395

### SUMMARY OF INVENTION

### Problems to be Solved by the Invention

However, in a technology described in Patent Document 1, there is a problem that the fork itself may collide with the container, the forks are not inserted into the container, and the container cannot be transported. Further, in a technology described in Patent Document 2, there is a problem that a cargo handling target must be marked, and a cargo handling target with no mark cannot be transported.

As described above, the technologies described in Patent Documents 1 and 2 have a disadvantage that a transport target may not be appropriately transported.

Therefore, an object of an aspect of the present invention is to provide a vehicle-mounted device, a cargo handling machine, a control circuit, a control method, and a program capable of appropriately transporting a transport target.

### Means for Solving the Problems

An aspect of the present invention has been made to solve the above-described problem and is a vehicle-mounted device including: an analysis unit that detects an insertion target into which an insertion blade is inserted, on the basis of sensing information acquired from a spatial recognition device; and a control unit hat performs a misalignment determination to determine whether or not a positional relationship between an insertion portion of the insertion target and the insertion blade is aligned on the basis of the sensing information.

Further, an aspect of the present invention is a cargo handling machine including the above-described vehicle-mounted device.

Further, an aspect of the present invention is a control circuit that determines whether or not a positional relationship between an insertion portion of an insertion target into which an insertion blade is inserted and the insertion blade is aligned, on the basis of sensing information acquired from a spatial recognition device.

Further, an aspect of the present invention is a control method including: detecting, by an analysis unit, an insertion target into which an insertion blade is inserted, on the basis of sensing information acquired from a spatial recognition device; and performing, by a control unit, a misalignment determination to determine whether or not a positional relationship between an insertion portion of the insertion target and the insertion blade is aligned on the basis of the sensing information.

Further, an aspect of the present invention is a program causing a computer to: detect an insertion target into which an insertion blade is inserted, on the basis of sensing information acquired from a spatial recognition device; and perform a misalignment determination to determine whether or not a positional relationship between an insertion portion of the insertion target and the insertion blade is aligned on the basis of the sensing information.

### Advantageous Effects of the Invention

According to the aspects of the present invention, it is possible to appropriately transport the transport target.

### BRIEF DESCRIPTION OF THE DRAWINGS

FIG. 1 is a perspective view illustrating transport work according to an embodiment of the present invention.

FIG. 2 is a front view illustrating an example of a fixed position of a work management device according to the embodiment.

FIG. 3 is a schematic diagram illustrating an example of sensing according to the embodiment.

FIG. 4 is a side view illustrating an example of sensing according to the embodiment.

FIG. 5 is a schematic diagram illustrating an example of a sensing result according to the embodiment.

FIG. 6 is a diagram illustrating an example of a misalignment determination according to the embodiment.

FIG. 7 is a schematic diagram illustrating another example of the misalignment determination according to the embodiment.

FIG. 8 is a schematic diagram illustrating still another example of the misalignment determination according to the embodiment.

FIG. 9 is a schematic diagram illustrating still another example of the misalignment determination according to the embodiment.

FIG. 10 is a schematic diagram illustrating still another example of the misalignment determination according to the embodiment.

FIG. 11 is a flowchart illustrating an example of an operation of a forklift according to the embodiment.

FIG. 12 is a block diagram illustrating a hardware configuration of a work management device according to the embodiment.

FIG. 13 is a block diagram illustrating a logical configuration of the work management device according to the embodiment.

FIG. 14 is another schematic block diagram illustrating a logical configuration of the work management device according to the embodiment.

FIG. 15A is a schematic diagram illustrating an example of a facing determination according to a modification example of the embodiment and is a diagram illustrating a case in which a forklift does not face a container.

FIG. 15B is a schematic diagram illustrating an example of a facing determination according to a modification example of the embodiment and is a diagram illustrating a case in which a forklift faces the container.

FIG. 16A is a schematic diagram illustrating an example of insertion timing prediction according to a modification example of the embodiment.

FIG. 16B is a schematic diagram illustrating an example of insertion tinning prediction according to a modification example of the embodiment and is a diagram illustrating a time when a forklift approaches a container.

### EMBODIMENTS FOR CARRYING OUT THE INVENTION

Hereinafter, embodiments of the present invention will be described in detail with reference to the drawings.

### <Transport Work>

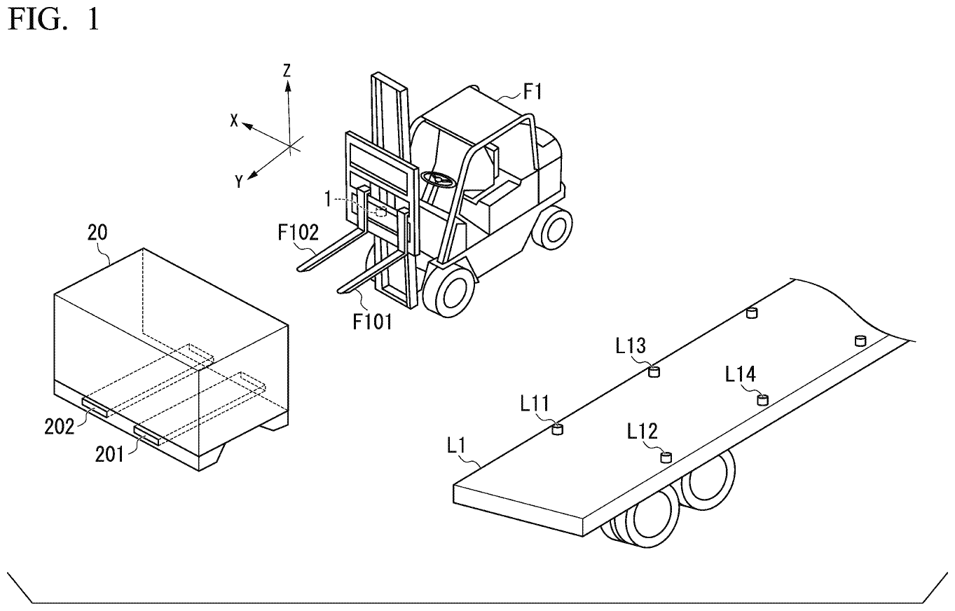

FIG. 1 is an illustrative diagram illustrating a transport work according to an embodiment of the present invention. A forklift F1 is an example of a cargo handling machine. Forks F101 and F102 are provided in the forklift F1. The forks F101 and F102 are examples of insertion blades.

The forklift F1 grips and transports a transport target such as a load or a pallet by inserting the forks F101 and F102 into the transport target. That is, the insertion blade that grips the transport target by being inserted into the transport target is provided in the cargo handling machine.

A container 20 is an example of the transport target or an insertion target. The container 20 is a container for storing a cargo or the like therein. Openings (insertion portions; may be concave portions) of the fork pockets 201 and 202 are provided in the container 20. The fork pockets 201 and 202 are holes or concave portions into which the forks F101 and F102 are inserted, respectively. The fork pockets 201 and 202 are an example of insertion targets.

A surface facing the forklift F1 (also referred to as an “insertion surface 211”) at the time of the insertion or the transport has the fork pockets 201 and 202. The fork pockets 201 and 202 are holes or concave portions in which the forks F101 and F102 are inserted from a front surface (an insert surface 211) to a back surface (a positive of a Y axis FIG. 1) of the transport target, and that have distal end portions projecting from a back surface.

In FIG. 1, the fork pockets 201 and 202 are holes extending straight in a normal direction of the insertion surface 211 in a lower portion of the insertion surface 211.

When the forks F101 and F102 are inserted straight into the fork pockets 201 and 202, respectively, the forklift F1 can grip the container 20 appropriately (with a good balance and stability) and transport the container 20.

It should be noted that the dimension or the like of the container 20 or the fork pockets 201 and 202 is defined by a standard (for example, JIS). Further, the transport target is not limited to the container 20, may be a pallet, or may be both of the pallet and a cargo placed on the pallet. Here, the pallet refers to a cargo handling platform for loading the cargo. The fork pockets are provided in the pallet. Further, there may be three or more (for example, four) fork pockets.

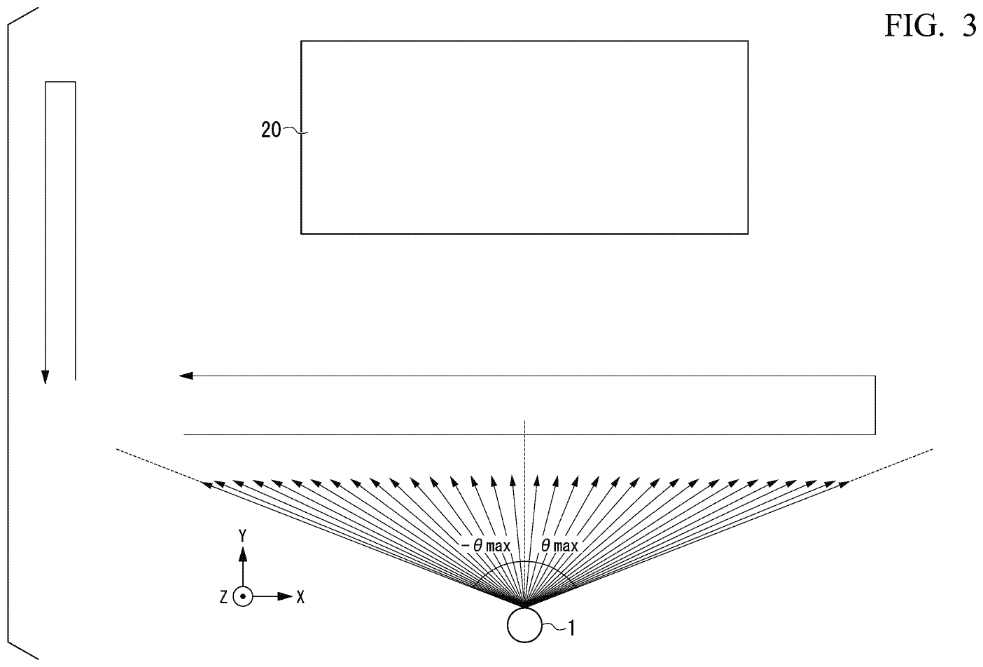

A work management device 1 is attached and fixed to a cargo handling machine. The work management device 1 includes, for example, a spatial recognition sensor such as a laser sensor. A case in which the spatial recognition sensor is a laser sensor will be described in the embodiment. That is, the work management device 1 (a spatial recognition sensor) radiates laser light, receives reflected light, and senses a distance R from the work management device 1 to each object. The work management device 1 repeats this for a range of sensing target. The work management device 1 recognizes a space, for example, according to an irradiation direction of the laser light and the distance R to each object (see FIGS. 3 to 6).

The work management device 1 detects the container 20 (or the insertion surface 211) on the basis of sensing information obtained from the spatial recognition sensor. The work management device 1 performs a misalignment determination to determine whether or not a positional relationship between the fork pockets 201 and 202 of the container 20 (or the insertion surface 211) and the forks F101 and F102 are not misaligned on the basis of the sensing information.

Here, the positional relationship is, for example, a positional relationship (a positional relationship projected onto a surface) in a plane (an XZ plane) perpendicular to a direction in which the forklift F1 and the container 20 face each other, but the present invention is not limited thereto. The positional relationship may be a positional relationship in a XY plane or a YZ plane. It should be noted that the direction in which the forklift F1 and the container 20 face each other also a direction in which the forks F101 and F102 are inserted, or a traveling direction of the forklift F1 (a case in which the forklift travels straight).

The work management device 1 outputs a determination result. For example, when the work management device 1 determines that the positional relationship is misaligned, the work management device 1 outputs a warning (for example, a warning sound, warning light, a warning image, or guidance).

Accordingly, the work management device 1, for example, can notify a worker or the like whether or not the fork pockets 201 and 202 and the forks F101 and F102 are misaligned (also referred simply to as “forks are misaligned”). That is, the worker or the like can change a position of the forklift F1 or positions (for example, heights) of the forks F101 and F102 according to a warning. As a result, the worker or the like can accurately insert the forks F101 and F102 into the fork pockets 201 and 202.

A loading platform L1 is an example of a carrying-out destination. The loading platform L1 is a loading platform for a truck or a trailer, a freight car for a freight train, or the like. Tightening devices L11 to L14 are provided in the loading platform L1. The tightening device is a device that is used to connect or fix the container 20.

The container 20 is gripped and transported by the forklift F1, placed on the loading platform L1, and fixed to the loading platform L1 by the tightening devices L11 to L14.

It should he noted that coordinate axes X, Y, and Z illustrated in FIG. 1 are common coordinate axes in the respective drawings of the embodiment and a modification example thereof.

### <Forklift>

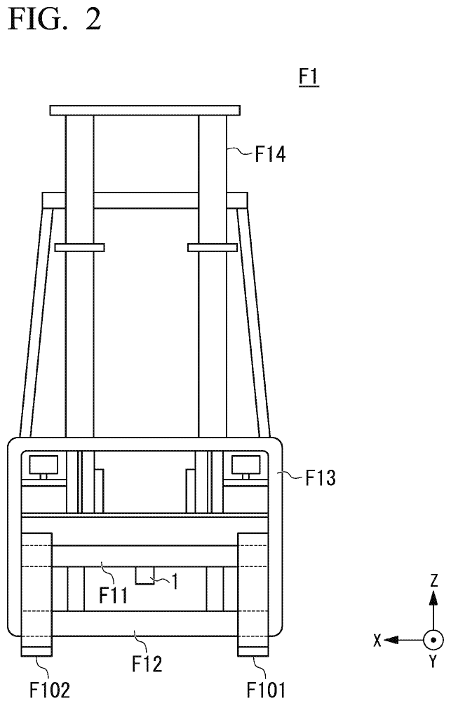

FIG. 2 is a schematic diagram illustrating an example of a fixed position of the work management device 1 according to the embodiment.

FIG. 2 is a front view of the forklift F1.

Fork rails F11 and F12 (finger bars) are rails for attaching the forks F101 and F102. It should be noted that the fork F101 or the fork F102 are slid along the fork rails F11 and F12 such that an interval between the fork F101 and the fork F102 can be adjusted.

A backrest is attached to the fork rails F11 and F12. The backrest F13 is a mechanism that prevents the gripped container 20 from collapsing or being dropped to the forklift F1.

A mast F14 is a rail for moving the forks F101 and F102 up and down. When the fork rails F11 and F12 are moved up and down along the mast F14, the forks F101 and F102 are moved up and down.

The work management device 1 is fixed to a central portion (in the X-axis direction) of the fork rail F11, which is the lower surface side (the lower side) of the fork rail F11. However, the work management device 1 may be attached to the upper surface side (the upper side) of the fork rail F11 or the like. Further, the work management device 1 may be attached to the fork rail F12, the backrest F13, the mast F14, or a vehicle body of the forklift F1. Further, a plurality of work management devices 1 or spatial recognition sensors may be attached.

It should be noted that when the work management device 1 is fixed to the fork rail F11, the fork rail F12, and the backrest F13, the container 20 can be irradiated with the laser light without the laser light radiated by the spatial recognition device being blocked. In this case, since the fork rail the fork rail F12, and the backrest F13 move up and down together with the forks F101 and F102 or the container 20, a relative positional relationship between these and the work management device 1 can be fixed.

<Sensing>

Hereinafter, sensing in the work management device 1 (a spatial recognition sensor) will be described.

It should be noted that, in the embodiment, a laser light irradiation scheme in a case in which the work management device 1 performs raster scanning will be described, but the present invention is not limited thereto and another irradiation scheme (for example, Lissajous scan) may be used.

FIG. 3 is a schematic diagram illustrating an example of sensing according to the embodiment.

FIG. 3 is a diagram in a case in which sequentially radiated laser light is viewed from the upper surface side of the forklift F1. It should be noted that, in FIG. 3, an angle (a polar angle of polar coordinates) in a case in which projection onto an XY plane is performed in a projection direction of the laser light is set to 0. An axis initial optical axis to be described below) that is an axis parallel to a Y axis and passing through the work management device 1 (an irradiation port) is set to θ=0.

The work management device 1 performs scanning in a horizontal direction (with other polar angles ϕ made constant) by sequentially radiating the laser light in the horizontal direction.

More specifically, the work management device 1 radiates the laser light sequentially (for example, at each equal angle Δθ) in a positive direction of the polar angle θ. The work management device 1 irradiates a specific range in the horizontal direction (a range in which a polar angle projected on an XY plane is −θmax≤θ≤θmax) with the laser light (also referred to as “horizontal scanning”), shifts an irradiation direction of the laser light in the vertical direction, and then, radiates the laser light the negative direction of the polar angle θ.

When the horizontal scanning in the negative direction of the polar angle θ is completed, the work management device 1 further shifts the irradiation direction of the laser light in the vertical direction, and performs the horizontal scanning in the positive direction of the X axis again.

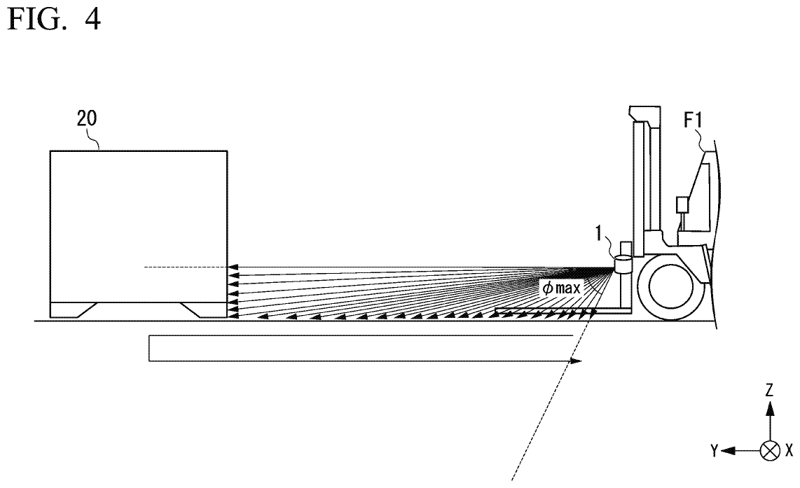

FIG. 4 is another schematic diagram illustrating an example of sensing according to the embodiment

FIG. 4 is a diagram in a case in which irradiation with the laser tight is viewed from the side surface of the forklift F1. It should be noted that horizontal scanning in FIG. 3 corresponds to one, of arrows in FIG. 4.

In FIG. 4, an angle (a polar angle of polar coordinates) when projection onto a YZ plane is performed in the projection direction of the laser light is set to ϕ. An axis (an initial optical axis) that is an axis parallel to a Y axis and passing through the work management device 1 (an radiation port) is set to ϕ=0.

The work management device 1 shifts the laser light by an equal angle Δϕ in a direction of the polar angle for each horizontal scanning. More specifically, the work management device 1 performs horizontal scanning in a positive direction of the polar angle θ, and then, shifts the irradiation direction of the laser light by the equal angle Δϕ in the positive direction of the polar angle ϕ. Thereafter, the work management device 1 performs horizontal scanning in the negative direction of the polar angle θ, and then, further shifts the irradiation direction of the laser light by the equal angle Δϕ in the positive direction of the polar angle ϕ.

The work management device 1 repeats this operation and irradiates a specific range (for example, range of −ϕmax (for example, ϕmax=90°≤ϕ≤0) in the positive direction of the polar angle ϕ. It should he noted that the work management device 1 may reverse the irradiation in the negative direction of the polar angle ϕ after shifting the irradiation by the specific range (ϕ=0).

It should be noted that the work management device 1 may radiate the laser light in another order or another coordinate system.

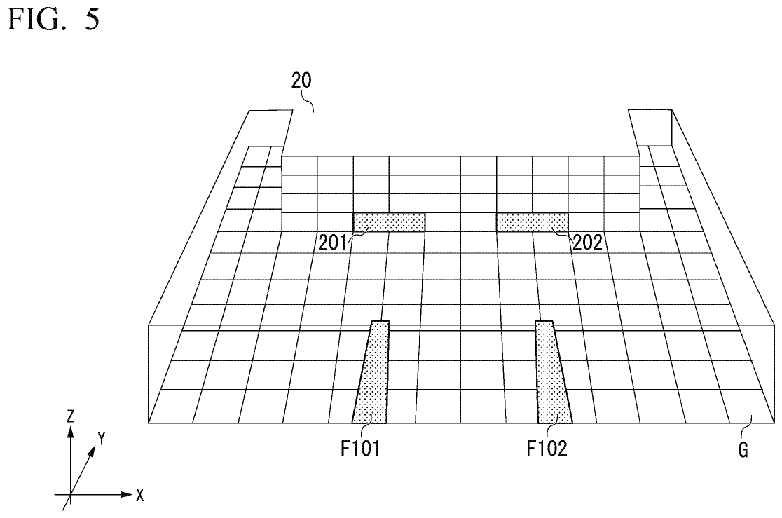

FIG. 5 is a schematic diagram illustrating an example of a sensing result according to the embodiment.

FIG. 5 illustrates sensing information indicating the sensing result an example of the sensing in FIGS. 3 and 4. The sensing information is, for example, space coordinates. The work management device 1 calculates this space coordinate on the basis of the irradiation direction (the polar angle θ and the polar angle ϕ) of the laser light and the distance R to a reflection source (an object). The space coordinates are coordinates representing a position of the reflection source in a sensing range. FIG. 5 is a diagram schematically illustrating the space coordinates.

In FIG. 5, the work management device 1 detects the container 20, the fork pockets 201 and 202 of the container 20, and the forks F101 and F102. It should be noted that a surface denoted by reference sign G is a road surface G.

The work management device 1 detects the container 20 (at least a part of the insertion surface 211) and the fork pockets 201 and 202 of the container 20 through a first detection process. In an example of the first detection process, for example, the work management device 1 sets a flat or substantially flat surface (including a surface having unevenness) as a plane, and detects a plane standing perpendicularly (in a vertical direction) or substantially perpendicularly to a ground or a floor surface. When the work management device 1 detects the fork pockets 201 and 202 in this plane, the work management device 1 determines that the plane is the insertion surface 211 of the container 20.

Here, the work management device 1, for example, detects, as the fork pockets 201 and 202, a portion in which the reflected light of the laser light is not detected and a portion in which a reception level of the reflected light of the laser light is low in the detected plane or a lower portion of the plane.

It should be noted that the work management device 1 may detect, as the fork pockets 201 and 202, a portion in which a distance equal to or greater than a predetermined value is changed (far away) with respect to a distance to the plane in the detected plane or a lower portion of the plane.

Further, the work management device 1 may detect the fork pockets 201 and 202 from the detected plane using the sensing information and the pocket position information. Here, the pocket position information is information indicating a combination of the dimension of the container 20 and a position or the dimension (shape) of the fork pockets 201 and 202 in the container 20, or information indicating a pattern of this combination. That is, for example, when there is a predetermined ratio or more of a portion in which the reception level of the reflected light of the laser light is low, at positions at which there are the fork pockets 201 and 202 on the basis of the pocket position information, the work management device 1 may determine that there are the fork pockets 201 and 202 based on the pocket position information.

The work management device 1 detects the forks F101 and F102 through a second detection process.

In an example of the second detection process, for example, the work management device 1 detects a plane extending a specific length or more in a Y-axis direction among planes parallel car substantially parallel to the XY plane, which is a portion smaller than a specific width in the X-axis direction, as the forks F101 and F102. 11 should be noted that the work management device 1 may store positions and shapes of the forks F101 and F102 in advance.

### <Misalignment Determination>

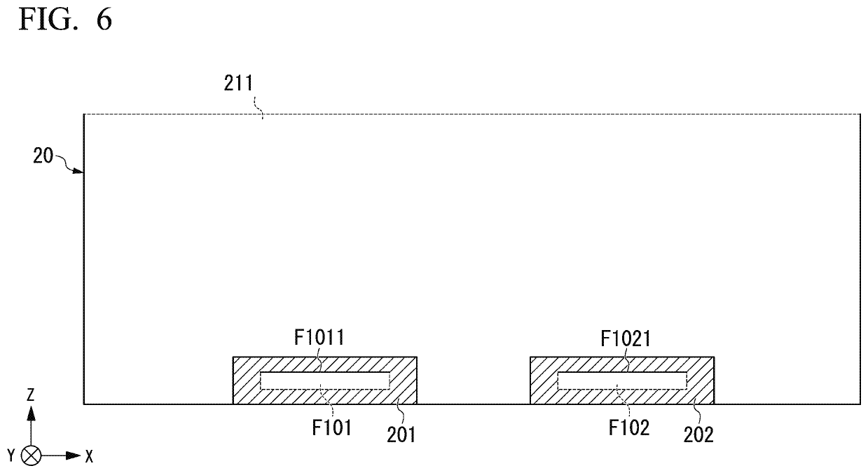

FIG. 6 is a schematic diagram illustrating an example of a misalignment determination according to the embodiment.

FIG. 6 is a diagram in a case in which a determination is made that the forks are not misaligned in the misalignment determination. FIG. 6 is a diagram in which the sensing information of FIG. 5 is projected onto the XZ plane. In FIG. 6, the object (the reflection source) detected by the work management device 1 is indicated by a solid line.

It should be noted that the work management device 1 detects the upper surfaces F1011 and F1021 of the forks F101 and F102 when the work management device 1 is attached to the position in FIG. 2, but cannot detect the lower surfaces or the side surfaces of the forks F101 and F102 in some cases. In this case, for example, the work management device 1 stores predetermined thickness information and sets the thickness indicated by the thickness information as a thickness of the forks F101 and F102 (a length of side surface; a length in the Z-axis direction). The work management device 1 estimates that the forks F101 and F102 are present over the thickness indicated by the thickness information in the thickness direction (the Z-axis direction) from the upper surfaces F1011 and F1021 of the detected forks F101 and F102.

Specifically, the work management device 1 estimates a shape indicated by a broken line in FIG. 6 for the forks F101 and F102. However, the present invention is not limited thereto, and the work management device 1 may detect the lower surface or the side surface of the forks F101 and F102 using another spatial recognition device.

In FIG. 6, the forks F101 and F102 are located within a range of the fork pockets 201 and 202, respectively. In this case, when the forklift F1 moves forward in a straight line in the Y-axis direction, the forks F101 and F102 can be inserted into the fork pockets 201 and 202, respectively, without colliding with the container 20.

When the forks F101 and F102 are respectively located in the range of the fork pockets 201 and 202 in the projection of the XZ plane as illustrated in FIG. 6, the work management device 1 determines that the fork pockets 201 and 202 and the forks F101 and F102 are not misaligned (the forks are not misaligned).

The work management device 1 may determine that the forks are not misaligned when a gap (a length of a gap in the X-axis direction or Z-axis direction) between (a surface; an outer surface of) the forks F101 and F102 and (a surface; an inner surface of) the fork pockets 201 and 202 is equal to or greater than a predetermined distance in the projection of the XZ plane. In other words, the work management device 1 may determine that the forks are misaligned when the gap between the forks F101 and F102 and the fork pockets 201 and 202 is smaller than a predetermined distance in the projection of the XZ plane.

Further, the work management device 1 may determine that the forks are not misaligned when centers of the forks F101 and F102 (intersections of diagonals) are within a predetermined range from centers of the fork pockets 201 and 202 (intersections of the diagonals) in the projection of the XZ plane, and may determine hat the forks are misaligned when centers are not within the predetermined range. The predetermined range may be a distance between two points or may be a distance between an X component and a Z component.

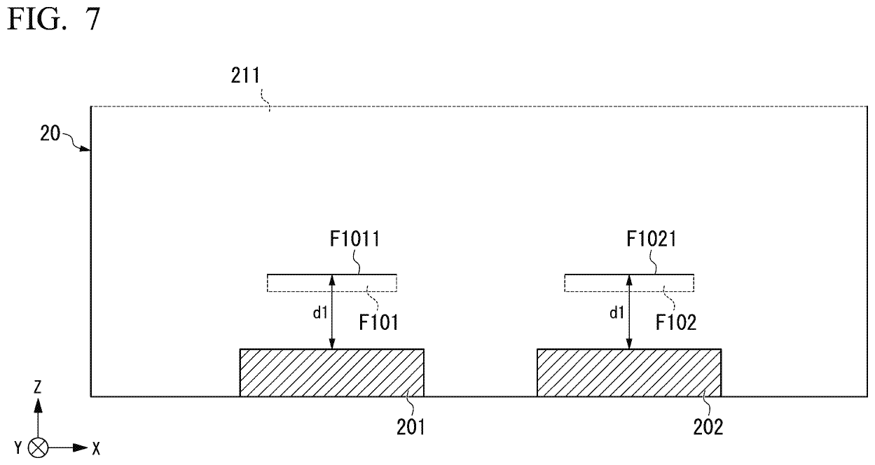

FIG. 7 is a schematic diagram illustrating another example of the misalignment determination according to the embodiment.

FIG. 7 is a diagram in a case in which a determination is made that the fork is misaligned in the misalignment determination. FIG. 7 is a diagram in which the sensing information is projected on an XZ plane. In FIG. 7, the object (the reflection source) detected by the work management device 1 is indicated by a solid line.

In FIG. 7, the forks F101 and F102 are located outside a range of the fork pockets 201 and 202, respectively. Specifically, the forks F101 and F102 are located in an upward direction (a positive direction of the Z axis) of the fork pockets 201 and 202, respectively. In this case, when the forklift F1 moves forward in a straight line in the Y-axis direction, the forks F101 and F102 collide with the container 20 (the insertion surface 211) and cannot be inserted into the fork pockets 201 and 202.

As illustrated in FIG. 7, the work management device 1 determines that forks are misaligned when the fork F101 is located outside the range of the fork pocket 201 in the projection of the XZ plane or when the fork F102 is located outside the range of the fork pocket 202.

Here, when the fork F101 or F102 is aligned in a vertical direction axis direction) of the fork pocket 201 or 202, the work management device 1 may determine that the fork is misaligned in a “height direction” as a type of misalignment. Further, the work management device 1 may determine that the fork is misaligned by “d1” in the height direction as the amount of misalignment. Further, the work management device 1 may output information based on the type or amount of misalignment.

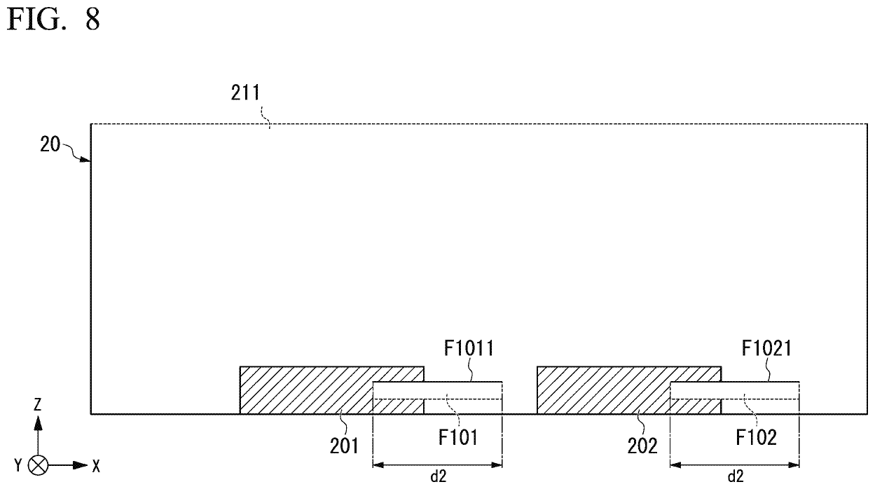

FIG. 8 is a schematic diagram illustrating another example of the misalignment determination according to the embodiment.

FIG. 8 is a diagram in a case in which a determination is made that the fork is misaligned in the misalignment determination. FIG. 8 is a diagram in which the sensing information is projected on an XZ plane. In FIG. 8, the object (the reflection source) detected by the work management device 1 is indicated, by a solid line.

In FIG. 8, the forks F101 and F102 are located outside the range of the fork pockets 201 and 202, respectively. Specifically, the forks F101 and F102 are located in a right direction (a positive direction of the X axis) of the fork pockets 201 and 202, respectively. In this case, the forklift F1 moves forward in a straight line in the Y-axis direction, the forks F101 and F102 collide with the container 20 (the insertion surface 211) and cannot be inserted into the fork pockets 201 and 202.

When the fork F101 is located outside the range of the fork pocket 201 and when the fork F102 is located outside the range of the fork pocket 202 in the projection of the XZ plane as illustrated in FIG. 8, the work management device 1 determines that the fork is misaligned.

Here, when the fork F101 or F102 is aligned in a right-left direction (the X-axis direction) of the fork pocket 201 or 202, respectively, the work management device 1 may determine that the fork is misaligned in the “horizontal direction” as a type of misalignment. Further, the work management device 1 may determine that the amount of misalignment is “d2” in a lateral direction. Further, the work management device may output information based on the type or amount of misalignment.

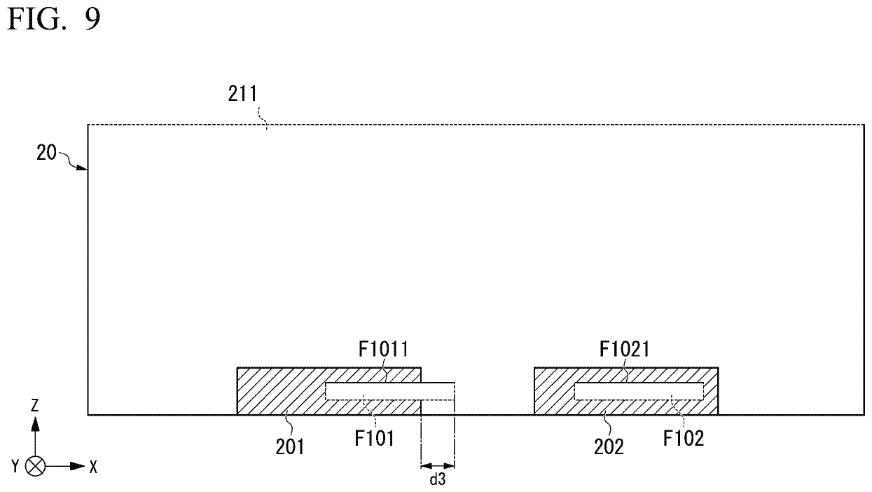

FIG. 9 is a schematic diagram illustrating another example of the misalignment determination according to the embodiment.

FIG. 9 is a diagram in a case in which a determination is made that the fork is misaligned in the misalignment determination. FIG. 9 is a diagram in which sensing information is projected onto the XZ plane. In FIG. 9, the object (the reflection source) detected by the work management device 1 is indicated by a solid line.

In FIG. 9, one of the forks F101 and F102 is located outside the range of the fork pockets 201 and 202, respectively. Specifically, the fork F101 is located in the right direction (the positive direction of the X axis) of the fork pocket 201. In this case, when the forklift F1 moves forward in a straight line in the Y-axis direction, the fork F101 collides with the container 20 (the insertion surface 211) and cannot be inserted into the fork pocket 201.

FIG. 9 illustrates that an interval between the forks F101 and F102 does not match an interval between the fork pockets 201 and 202. In the example of FIG. 9, it is necessary to widen the interval between the forks F101 and F102.

As illustrated in FIG. 9, when the fork F101 is located outside the range of the fork pocket 201 in the projection of the XZ plane or when the fork F102 is located outside the range of the fork pocket 202, the work management device 1 determines that the fork is misaligned.

In this case, the work management device 1 may determine that the “width” of the fork is misaligned as a type of misalignment. Further, the work management device 1 may determine that the fork is misaligned by “d3” in a lateral direction as the amount of misaligment. Further, the work management device 1 may output information based on the mount of misalignment.

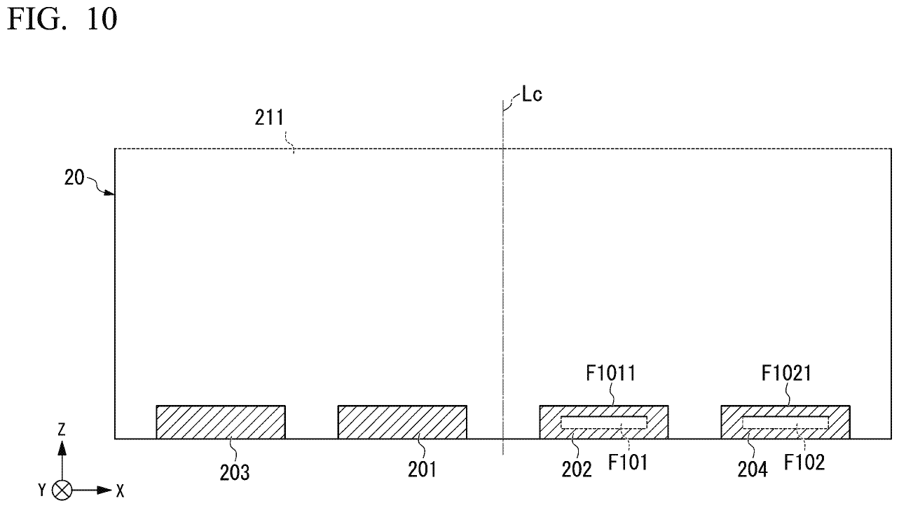

FIG. 10 is a schematic diagram illustrating another example of the misalignment determination according to the embodiment.

FIG. 10 is a diagram in a case in which a determination is made that the fork is misaligned in the misalignment determination, FIG. 10 is a diagram in which the sensing information is projected onto the XZ plane. In FIG. 10, the object (the reflection source) detected by the work management device 1 is represented by a solid line.

In FIG. 10, four fork pockets 201, 202, 203, and 204 are provided in the container 20. In this case, it is necessary for the forklift F1 to insert the forks F101 and F102 into any one of a combination of the fork pockets 201 and 202 line-symmetrical to a center line (a symmetrical axis Lc) of the container 20 in the right-left direction (the X-axis direction; a width direction of the container 20) and a combination of the fork pockets 203 and 204, and grip the container 20.

In FIG. 10, the forks F101 and F102 are respectively located within a range of the fork pockets 201, 202, 203, and 204 in a combination (also referred to as an “inappropriate combination of the pockets”) that is not line-symmetrical to the center line of the container 20. Specifically, the forks F101 and F102 are located in the range of the fork pockets 202 and 204, respectively. In this case, when the forklift F1 moves forward in a straight line in the Y-axis direction, the forks F101 and F102 can be inserted into the fork pockets 202 and 204, respectively. However, since a center of the container 20 is not located between the forks F101 and F102, the forklift F1 cannot grip the container 20 in a well-balanced manner.

When the forks F101 and F102 are located within a range of an inappropriate combination of the pockets in the projection of the XZ plane as illustrated in FIG. 10, the work management device 1 determines that the forks are misaligned, that is, the forks are misaligned from an appropriate combination of pockets.

In this case, the work management device 1 may determine that the forks are misaligned from an “appropriate combination of pockets” or an “inappropriate combination of the pockets” as a type of misalignment.

It should be noted that the work management device 1 may select an appropriate combination of pockets on the basis of the detected number of fork pockets and an order of arrangement. As an example, in a case in which the work management device 1 detects four fork pockets when the forklift is a two-blade fork, the work management device 1 selects a combination of the second and third fork pockets or a combination of the first and fourth fork pockets in the X-axis direction as the appropriate combination of the pockets.

### <Operation of Forklift>

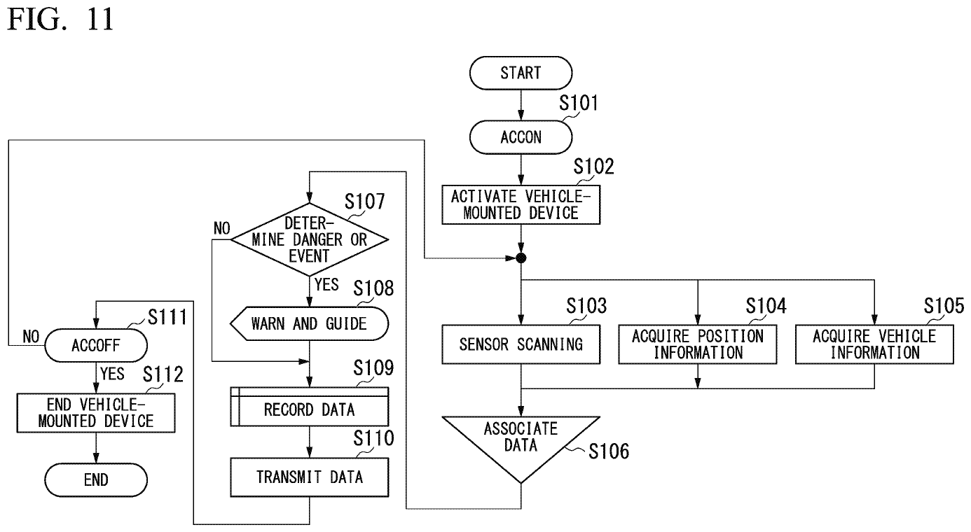

FIG. 11 is a flowchart illustrating an example of an operation of the forklift F1 according to the embodiment.

(Step S101) The forklift F1 starts up the engine through an operation of the worker or the like (ACC ON). Thereafter, the process proceeds to step 5102.

(Step S102) The vehicle-mounted device such as the work management device 1 is activated by acquiring information indicating that power is supplied or the engine is started up. Then, the process proceeds to steps S103, S104, and S105.

(Step S103) The work management device 1 acquires sensing information representing a space using the spatial recognition sensor. Specifically, the work management device 1 radiates the laser light and senses the distance to the object (sensor scanning). Thereafter, the process proceeds to step S106.

(Step S104) The work management device 1 acquires position information indicating a position of the forklift F1 (the work management device 1). The position information is, for example, a positioning result of a global positioning satellite system (GNSS). However, the position information may be a positioning result using another wireless communication (for example, a wireless LAN or an RFID tag). Thereafter, the process proceeds to step S106.

(Step S105) The work management device 1 acquires vehicle information indicating a state of the forklift F1 or an operation of a worker or the like. Thereafter, the process proceeds to step S106.

Here, the vehicle information is data that the forklift F1 can output, such as speed, the steering angle, accelerator operation, brake operation, gears (forward, reverse, high speed, low speed, or the like), the manufacturer, the vehicle type, or vehicle identification information of the forklift F1. Further, the vehicle information may include a position (height) of the forks F101 and F102, the presence or absence of the gripped transport target or a weight thereof, a load situation of a lift chain, fork information indicating a types of the forks F101 and F102, or the like, identification information of a worker (a driver), identification information of a work place (a warehouse or a factory) or a company, or work information indicating identification information of a gripped (transported) transport target (for example, acquired by an RFID attached to the transport target, or the like).

(Step S106) The work management device 1 associates the sensing information acquired in step S103, the position information acquired in step S104, and the vehicle information acquired in step S105 (associated data is also referred to as “association data”). For example, the work management device 1 associates the sensing information, the position information, and the vehicle information together with the device identification information of the work management device 1 and an acquisition date and time. Thereafter, the process proceeds to step S107.

(Step S107) The work management device 1 determines the presence or absence of danger or an event on the basis of the association data associated in step S106. For example, the work management device 1 performs the above misalignment determination on the basis of the association data. When a determination is made that there is a danger or an event (yes), the process proceeds to step S108. On the other hand, when a determination is made that there is no danger or event (no), the process proceeds to step S109.

(Step S108) The work management device 1 outputs a warning (including guidance) on the basis of a type of danger or event determined in step S107 or data associated with the type. Thereafter, the process proceeds to step S109.

(Step S109) The work management device 1 associates the association data, determination information indicating a determination result in step S107, or output information indicating an output result of the warning in step S103 with one another, and records associated data in the recording device or the like. Thereafter, the process proceeds to step S110.

(Step S110) The work management device 1 transmits the data associated in step S109 to a server or the like. Thereafter, the process proceeds to step S111.

It should be noted that this server is, for example, an information processing device that comprehensively collects and manages data from a plurality of forklifts F1 at a work place or a company. The data transmitted to the server is analyzed using a statistical processing function or a machine learning function. The data transmitted to the server or data of an analysis result is used for driving education or the like. For example, driving data of the worker who is good at loading of the transport target or that is efficient is used as a model. On the other hand, when the transport target is damaged or dropped, data in this used for cause investigation or improvement.

(Step S111) When the engine of the forklift F1 is stopped due to an operation of the worker or the like (yes), the process proceeds to step S112. On the other hand, when the engine of the forklift F1 is not stopped (no), the process proceeds to steps S103, S104 and S105. That is, the work management device 1 performs the acquisition information using sensing or the like, and the data association, recording, and transmission until the engine is stopped.

(Step S112) The vehicle-mounted device such as the work management device 1 stops or enters a sleep state by acquiring information indicating that the supply of power is stopped or the engine is stopped. Thereafter, the operation ends.

### <Configuration of Work Management Device>

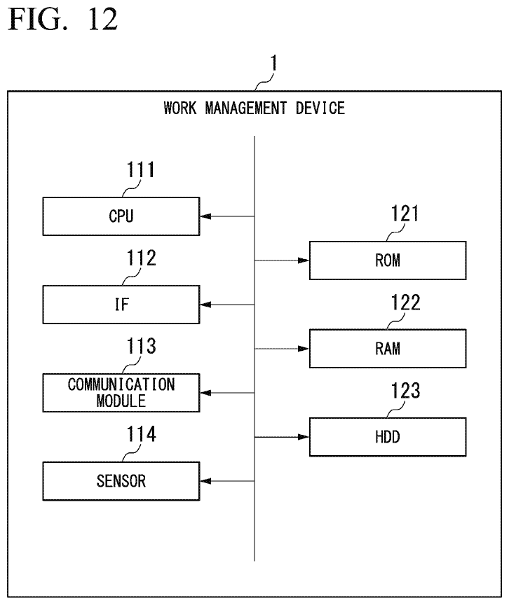

FIG. 12 is a schematic block diagram illustrating a hardware configuration of the work management device 1 according to the embodiment. In FIG. 12, work management device 1 includes a central processing unit (CPU) 111, an interface (IF) 112, a communication module 113, a sensor 114 (for example, a spatial recognition sensor), a read only memory (ROM) 121, a random access memory (RAM) 122, and a hard disk drive (HDD) 123. The IF 112 is, for example, a portion (a driver's seat, a vehicle body, the mast F14, or the like) of the forklift F1 or an output device (a lamp, a speaker, a touch panel display, or the like) provided in the work management device 1. The communication module 113 performs transmission and reception of signals via a communication antenna. The communication module 113 is, for example, a communication chip such as a GNSS receiver or a wireless LAN. The sensor 114, for example, radiates laser light and performs sensing based on the received reflected light.

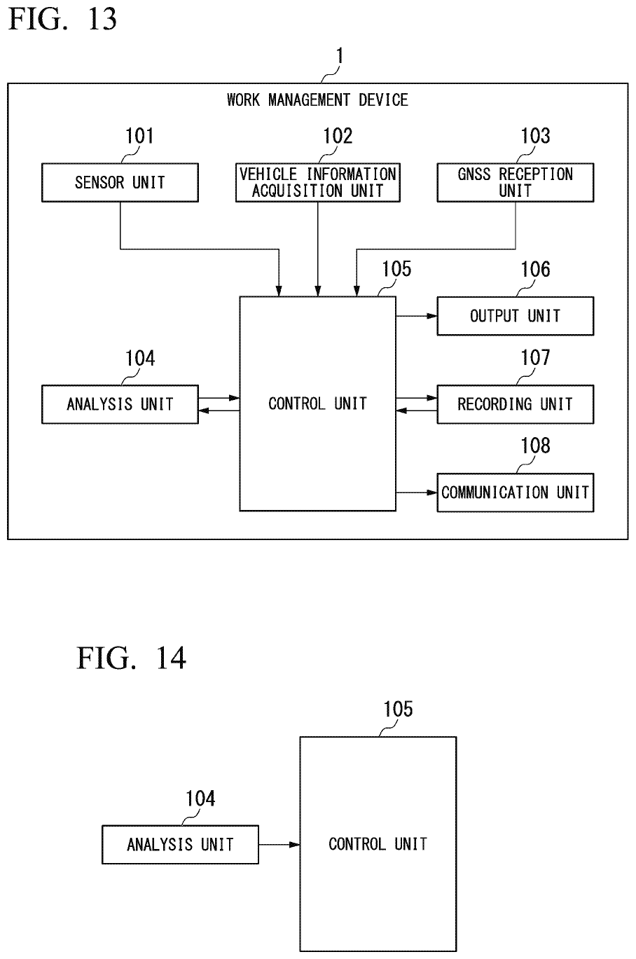

FIG. 13 is a schematic configuration diagram illustrating a hardware configuration of the work management device 1 according the embodiment. In FIG. 11, the work management device 1 includes a sensor unit 101, a vehicle information acquisition unit 102, a GNSS reception unit 103, an analysis unit 104, a control unit 105, an output unit 106, a recording unit 107, and a communication unit 108.

The sensor unit 101 is a spatial recognition sensor. The sensor unit 101 senses the distance R from the own device to each object, for example, using laser light, The sensor unit 101 recognizes a space on the basis of an irradiation direction (the polar angles θ and ϕ) of the laser light and the sensed distance R. It should be noted that the recognition of the space means generation of three-dimensional coordinates for a space including surrounding objects, the present invention is not limited thereto and the recognition of the space means generation of two-dimensional coordinates. The sensor unit 101 generates sensing information (for example, coordinate information) and outputs the sensing information to the control unit 105.

The vehicle information acquisition unit 102 acquires vehicle information from the forklift F1 and outputs the acquired vehicle information to the control unit 105.

The GNSS reception unit 103 acquires position information and outputs the acquired position information to the control unit 105.

The analysis unit 104 acquires the sensing information output by the sensor unit 101, the vehicle information output by the vehicle information acquisition unit 102, and the position information output by the GNSS reception unit from the control unit 105.

The analysis unit 104 generates association data by associating the acquired sensing information, vehicle information, and position information with one another. The analysis unit 104 analyzes the generated association data.

For example, the analysis unit 104 detects the insertion surface 211 (the container 20) by detecting the plane and the fork pockets 201 and 202 through the first detection process based on the sensing information. Further, the analysis unit 104 detects the forks F101 and F102 through the second detection process based on the sensing information.

The control unit 105 acquires the sensing information output by the sensor unit 101, the vehicle information output by the vehicle information acquisition unit 102, and the position information output by the GNSS reception unit, analyzes the information using, for example, the analysis unit 104, and performs the determination on the basis of an analysis result.

For example, the control unit 105 determines the presence or absence of a danger or an event. The control unit 105 performs the above-described misalignment determination as one of the determinations.

Specifically, the control unit 105 determines whether or not the forks are misaligned on the basis of a positional relationship in the sensing information, which a positional relationship between the forks F101 and F102 and the fork pockets 201 and 202. For example, when the control unit 105 performs projection onto the XZ the control unit 105 determines whether or not the forks are misaligned by determining whether or not the forks F101 and F102 are located in the range of the respective fork pockets 201 and 202.

The control unit 105 causes a warning eluding guidance) to be output from the output 106 on the basis of the determination result or data associated with the determination result. It should be noted that the output unit 106 may output information based on the type of displacement or the amount of displacement.

The control unit 105 records determination information indicating and data associated with the determination result on the recording unit 107, and transmits the determination information and the association data to a server or the like via the communication unit 108.

It should be noted that the sensor unit 101 is realized by the sensor 114 in FIG, 12. Similarly, the vehicle information acquisition unit 102 and the GNSS reception unit 113 103 are realized by the communication module 113, for example. The analysis unit 104 and the control unit 105 are realized by, for example, a CPU 111, a ROM 121, a RAM 122, or an HDD 123.

### (Conclusion of Embodiment)

As described above, in the embodiment, the work management device 1 is a vehicle-mounted device mounted in the forklift F1 (the cargo handling machine). As illustrated in FIG. 14, the work management device 1 (the forklift F1) detects the container 20 (an insertion target) into which the forks F101 and F102. (insertion blades) are inserted on the basis of h sensing information that the analysis unit 104 has acquired from the spatial recognition sensor (a spatial recognition device). The control unit 105 performs a misalignment determination to determine whether or not a positional relationship between the openings (insertion portions) of the fork pockets 201 and 202 and the forks F101 and F102 is aligned on the basis of the sensing information.

Accordingly, the work management device 1 can reliably insert the forks F101 and F102 into the fork pockets 201 and 202, and can appropriately transport the transport target, For example, the forklift F1 can prevent the fork pockets 201 and 202 from being damaged or destroyed. Further, the forklift F1 can grip the container 20 appropriately (with a good balance and stability) and transport the container 20, and can prevent the container 20 from being dropped.

Further, for example, even when the container 20 has no mark, the work management device 1 can reliably insert the forks F101 and F102 into the fork pockets 201 and 202, and can appropriately transport the transport target. However, the work management device 1 may be used together with the mark, or may grip the container 20 with a mark.

### <Modification Example A1>

In the above embodiment, the control unit 105 (the forklift F1 or the work management device 1) may determine that the forklift faces the insertion surface 211 having the openings of the fork pockets 201 and 202 on the basis of the sensing information (also referred to as a “facing determination”) and then may perform a misalignment determination or a warning based on the misalignment determination (also referred to as “misalignment determination or the like”). For example, the control unit 105 may perform the misalignment determination or the like after at least one time of the facing determination, and may not perform the misalignment determination or the like before at least one time of the facing determination.

Accordingly, the work management device 1 can cause the forklift F1 and the container 20 (the insertion surface 211) to face each other so that the forklift F1 and the container 20 face each other in a correct direction, and then, determine whether or not the forks are misaligned.

That is, the forklift F1 can insert the forks F101 and F102 into the fork pockets 201 and 202 straightly without misalignment.

Hereinafter, an example in which the work management device 1 performs the facing determination using the sensing information will be described. However, the present invention is not limited thereto, and the work management device 1 may perform another facing determination (for example, a facing determination using an RFID or a facing determination based on a captured image).

### <Facing Determination>

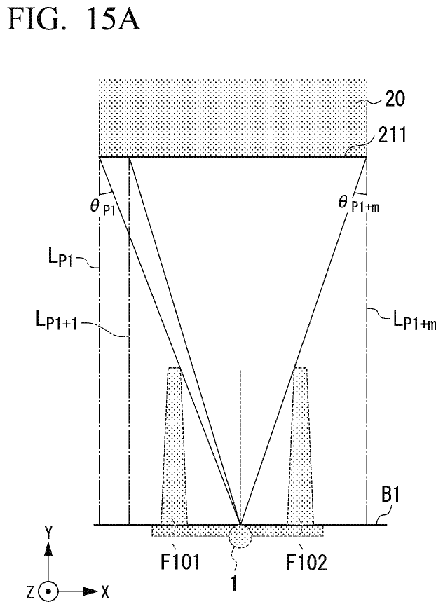

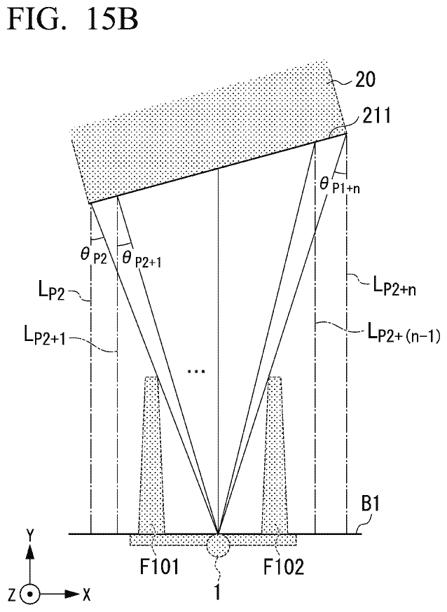

FIGS. 15A and 15B are schematic diagrams illustrating an example of the facing determination according to the embodiment.

FIG. 15A is a diagram in a case in which the forklift F1 faces the container 20. FIG. 15A is a diagram in which the sensing information of FIG. 5 has been projected onto the XY plane.

FIG. 15B is a diagram in a case in which the forklift F1 does not face the container 20. FIG. 15B is a diagram in which the sensing information in FIG. 6 has been projected onto the XY plane.

In FIGS. 15A and 15B, solid lines represent laser light. Further, in FIGS. 15A and 15B, the projection of the container 20, the forks F101 and F102, and the work management device 1 is described with a broken line for convenience.

In FIG. 15A, the work management device 1 detects a plane 211 in a range in which the polar angle θ is −θ_{P1}≤θ≤θ_{P1+m}.

In FIG. 15B, the work management device 1 detects the plane 211 in a range in which the polar angle θ is −θ_{P2}≤θ≤θ_{P2+n}. It should be noted that i in θᵢ represents an order in which the laser light is radiated in one horizontal scanning, that is, the number of irradiations. For example, θᵢ=−θₘₐₓ+i×Δθ.

When the work management device 1 detects the fork pockets 201 and 202 in the detected plane 211, the work management device 1 determines that the plane 211 is the insertion surface (the insertion surface 211) of the container 20.

The work management device 1 performs the facing determination to determine whether or not the forklift F1 faces the insertion surface 211 (the container 20) on the basis of the sensing information. For example, the work management device 1 performs the facing determination by determining whether or not the insertion surface 211 is parallel to a reference surface B1 (whether or not the insertion surface 211 is inclined). Here, the reference surface B1 is a plane parallel to an XZ plane aid is a surface perpendicular to a traveling direction when the forklift F1 travels straight. For example, the reference surface B1 is a plane including the work management device 1 (a projection port) in such a plane.

As a specific example of the facing determination, the work management device 1 calculates a distance Lᵢ (referred to as a “reference distance Lᵢ”) from the reference surface B1 of the forklift F1 to the insertion surface 211 on he basis of a distance Rᵢ from the work management device 1 to the object (the reflection source). Here, the distance Rᵢ represents a distance R detected through the i-th irradiation, which is a distance R from the work management device 1 to the object (the reflection source)

For example, in a case in which an irradiation direction is θᵢ and ϕ, the work management device 1 calculates the reference distance Lᵢ=Rᵢcos |ϕ|×cos |θᵢ| when the work management device 1 has detected the distance Rᵢ to the object. Here, ϕ represents a polar angle ϕ when the i-th irradiation has been performed.

The work management device 1 performs the facing determination on the basis of a difference ΔL_{i,j}=|Lᵢ−Lⱼ| between the reference distance Lᵢ and the reference distance Lⱼ (i≠j) on the insertion surface 211. As an example, the work management device 1 performs the facing determination on the basis of a difference ΔL_{i+1,i}=|Lᵢ₊₁−Lᵢ| between the reference distance Lᵢ and a reference distance Lᵢ₊₁ adjacent to each other.

In this case, the work management device 1 determines that the forklift F1 faces the insertion surface 211 (the container 20) when all of the differences ΔL_{i+1,i} are within a threshold value T1 in the insertion surface 211.

On the other hand, the work management device 1 determines that the forklift F1 does not face the insertion surface 211 (the container 20) when at least one of the differences ΔL_{i+1,i} is greater than the threshold value T1 in the insertion surface 211.

In FIG. 15A (when the forklift F1 completely faces), Lᵢ has the same value in a range of P1≤i≤P1+m. In this case, for example, in a range of P1≤i≤P1+m−1, a difference ΔL_{i+1,i}=|Lᵢ|=0≤T1. this case, the work management device 1 determines that the forklift F1 faces the insertion surface 211 (the container 20).

In FIG. 15B, Lᵢ is a different value in a range of P2≤i≤P2+n, and for example, Lᵢ is a monotonically increasing function of i. In this case, for example, a difference ΔL_{i+1,i}=|Lᵢ₊₁−Lᵢ|>T1 in a range of P1≤i≤P1+m−1. In this case, the work management device 1 determines that the forklift F1 does not face the insertion surface 211 (the container 20).

<Modification example A2>

In the above embodiment, the control unit 105 (the forklift F1 or the work management device 1) may perform the misalignment determination or the like on the basis of a timing t (also referred to as an “insertion timing t”) at which the forks F101 and F102 are located at or near the openings of the fork pockets 201 and 202. For example, the control unit 105 performs the misalignment determination or the like a predetermined time t1 before the insertion timing t.

Accordingly, the work management device 1 can prevent the warning from being output even when a need for the warning is low. It should be noted that the insertion timing t is also a timing at which the forks F101 and F102 begin to be inserted into the container 20. Further, the insertion timing t represents a time from a calculation time point to a time when the forks F101 and F102 are located at the openings of the fork pockets 201 and 202.

Specifically, the control unit 105 predicts the insertion timing t on the basis of the distance d_{c} between the distal end of the forks F101 and F102 and the opening (or the insertion surface 211) of the fork pockets 201 and 202 and the vehicle speed of the vehicle information (also referred to as “insertion timing prediction”). The control unit 105 performs the misalignment determination or the like in a predetermined time t1 before the insertion timing t. From the point of view, the control unit 105 does not perform the misalignment determination or the like until the predetermined time t1 before the insertion timing t.

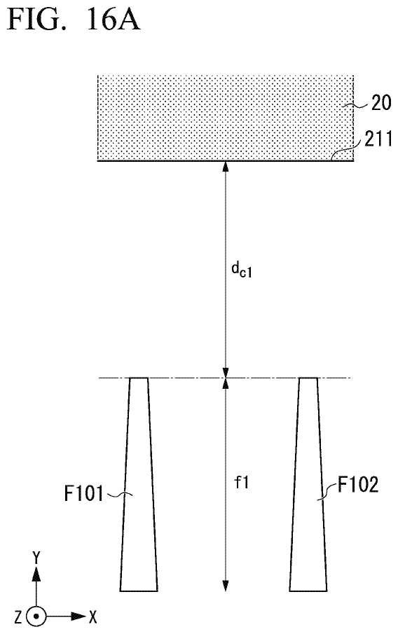

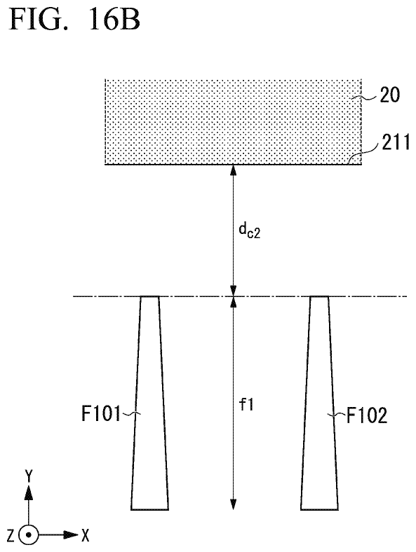

FIGS. 16A and 16B are schematic diagrams illustrating an example of the insertion timing prediction according to a modification example of the embodiment.

FIGS. 16A and 16B are diagrams in which sensing information is projected onto the XY plane. In FIGS. 16A and 16B, distances d_{C1} and d_{C2} are specific examples of the distance d_{c} between the distal end portion of the forks F101 and F102 and the opening (or the insertion surfaces 211) of the fork pockets 201 and 202, and a length f1 is a length of the forks F101 and F102 (a length in the Y-axis direction).

FIG. 16B is a diagram in a case in which the forklift F1 approaches the container 20, as compared with the case of FIG. 16A. When the vehicle speed is the same, the insertion timing t (a time required to start the insertion) in the case of FIG. 16B is shorter than in the case of FIG. 16A.

The control unit 105 calculates the distance d_{c}b, for example, by subtracting the length f1 from the distance between the insertion surface 211 and the reference surface B1. It should be noted that the control unit 105 may use, as the distanced d_{c}, the reference distance Lᵢ measured when the irradiation direction is a normal direction of the reference surface B1, that is, when θ=0 and ϕ=0 as the distance between the insertion surface 211 and the reference surface B1. It should be noted that the control unit 105 may detect the length f1 or may store the length f1 in advance.

The control unit 105 calculates the insertion timing t by dividing the calculated distance d_{c} by the vehicle speed. The control unit 105 performs the misalignment determination or the like when the calculated insertion timing t is within the time t1 stored in advance, and does not perform the misalignment determination or the like when the calculated insertion timing tis longer than the time t1.

### <Modification Example A3>

In the above embodiment, the control unit 105 (the forklift F1 or the work management device 1) may perform the misalignment determination or the like on the basis of a relative positional relationship between the forks F101 and F102 and the openings of the fork pockets 201 and 202.

Accordingly, the work management device 1 can prevent the warning from being output even when a need for the warning is also low.

Specifically, the control unit 105 performs the misalignment determination or the like on the basis of the positions of the distal ends of the forks F101 and F102 and the positions of the openings (or the insertion surfaces 211) of the fork pockets 201 and 202. For example, when the distance d_{c} becomes equal to or smaller than a predetermined distance d11 (for example, 1 m), the control unit 105 performs the misalignment determination or the like. In other words, the control unit 105 does not perform the misalignment determination or the like when the distance d_{c} is greater (farther) than the predetermined distance d11.

The control unit 105 uses, for example, the distance d_{c} from a middle point between the distal end of the fork F101 and the distal end of the fork F102 to the insertion surface 211 e FIGS. 16A and 16B), but the present invention is not limited thereto. The control unit 105 may use, as the distance d_{c}, a distance from either the distal end of the fork F101 or the distal end of the fork F102 to the insertion surface 211, or may use a value obtained by adding a predetermined distance f11 to the distal end of the fork F101 or subtracting the predetermined distance f11 from the distal end of the fork F101. Further, the distance to the insertion surface 211 is not limited to the normal direction of the insertion surface 211, but may be a no al direction of the reference surface B1, that is, a direction extending in a traveling direction of the forklift or an axial direction of the forks F101 and F102. Further, the distance to the insertion surface 211 may be a distance to a center line (the symmetrical axis Lc in FIG. 10) of the insertion surface 211. In this case, the insertion surface 211 may detect a side of the insertion surface 211 on the basis of the reference distance Lᵢ and calculate the center line, or may detect the side of the insertion surface 211 through edge detection or the like and calculate the center line.

### <Modification Example A4>

In the above embodiment, the control unit 105 (the forklift F1 or the work management device 1) may change the warning based on the misalignment determination on the basis of the insertion timing t.

For example, when the control unit 105 determines that the forks are misaligned and the insertion timing t is longer than t2, the control unit 105 performs a warning with a less noticeable warning (a lower output, such as a lower sound or dark light, a shorter time or a smaller number of times of blinking of a sound or light, or a wider interval of blinking of a sound or light), as compared with a case in which the insertion timing tis equal to or shorter than t2. On the other hand, when the control unit 105 determines that the forks are not misaligned and the insertion timing t is equal to or shorter than t2, the control unit 105 performs a warning with a more noticeable warning (a higher output, such as a higher sound or bright light, a longer time or a larger number of times of blinking of a sound or light, or a narrower interval blinking of a sound or light), as compared with a case in which the insertion timing t is longer than t2.

### <Modification Example A5>

In the above embodiment, the control unit 105 (the forklift F1 or the work management device 1) may change the warning based on the misalignment determination on the basis of the relative positional relationship between the forks F101 and F102 and the openings of the fork pockets 201 and 202.

For example, in a case in which the distance d_{c} larger (farther) than predetermined 103 distance d12 when the control unit 105 determines that the fork is misaligned, the control unit 105 performs a warning with a less noticeable warning (a lower output, such as a lower sound or dark light, a shorter time or a smaller number of times of blinking of a sound or light, or a wider interval of blinking of a sound or light), as compared with a case in which the distance d_{c} is smaller than (close to) the distance d12.

On the other hand, in a case in he distance d_{c} is equal to or smaller than (closer to) the predetermined distance d12 when the control unit 105 determines that the fork is misaligned, the control unit 105 performs a warning more noticeable warning (a higher output, such as a higher sound or bright light, a longer time or a larger number of times of blinking of a sound or light, or a narrower interval of blinking of a sound or light), as compared with a case in which the distance d_{c} is greater than (farther to) the distance d12.

### <Modification Example B1: Condition of Output or Misalignment Determination>

In the above embodiment, the control unit 105 (the forklift F1 or the work management device 1) may set conditions for performing or not performing the misalignment determination.

The control unit 105 may perform a warning based on the misalignment determination when the first condition to be described below is satisfied and may not perform the warning based on the misalignment determination when the first condition is not satisfied. Further, the control unit 105 may perform the misalignment determination or the sensing when the first condition is satisfied and may not perform the misalignment determination or the sensing when the first condition is not satisfied.

Further, the control unit 105 may change an interval of a warning based on the misalignment determination, or the misalignment determination or sensing (hereinafter referred to as a warning or the like) on the basis of the first condition.

The first condition is, for example, a condition that the distance between the container 20 and the forklift F1 is smaller than (closer to) the threshold value, as described above.

The first condition may be, for example, a condition based on the position information or the vehicle information. For example, when the forklift F1 enters a predetermined position (range) in a warehouse or the like, the control unit 105 may perform the warning or the like and may not perform the warning or the like at other positions.

For example, the control unit 105 may perform the warning or the like when the gear is in a forward direction, and may not perform the warning or the like otherwise.

For example, the control unit 105 may perform the warning or the like when a vehicle speed is lower than a threshold value, and may not perform the warning otherwise. On the other hand, the control unit 105 may perform the warning or the like when the vehicle speed is higher than the threshold value and may not perform the warning or the like otherwise.

For example, the control unit 105 may perform the warning or the like when a steering angle is smaller than a threshold value and may not perform the warning or the like otherwise.

The first condition may be, for example, a condition based on fork information or work information.

For example, the control unit 105 may perform the warning or the like when there is no gripped transport target, and may not perform the warning or the like when there is a gripped transport target. The control unit 105 may perform the warning or the like when the position (height) of the forks F101 and F102 is lower than the threshold value and may not perform the warning the like when the position (height) of the forks F101 and F102 are higher than the threshold value.

For example, the control unit 105 may perform the warning or the like when a specific worker drive and may not perform the warning or the like in other cases.

The first condition may be, for example, a condition that the forks F101 and F102 are not pulled out.

For example, when the forks F101 and F102 are not pulled out, the control unit 105 performs the warning or the like and does not perform the warning or the like when the forks F101 and F102 are pulled out. Further, the control unit 105 may perform the warning or the like when the gear is in a forward direction and may not perform the warning or the like when the gear is in the reverse direction.

It should be noted that, as illustrated in FIG. 2, in a case in which the work management device 1 is fixed to a central portion of the forklift F1 in an X-axis direction, the work management device 1 can be located in a central portion of the fork F101 and the fork F102 or a central portion of the fork pocket 201 and the fork pocket 202 when the forklift F1 tries to grip the container 20 appropriately.

Further, when the work management device 1 is fixed to the fork rail F11 or the backrest F13, the work management device 1 can more easily recognize the forks F101 and F102, as compared to a case in which the work management device 1 is fixed to the fork rail F12. That is, since the work management device 1 and the forks F101 and F102 are separated in a height direction (the X-axis direction), the work management device 1 can further recognize shapes in a length direction (the Y-axis direction) of the forks F101 and F102 (see FIGS. 3 and 5).

Further, when the work management device 1 is fixed to the fork rail F11 or F12, the work management device 1 can more easily recognize the fork pockets 201 and 202, as compared to a case in which the work management device 1 is fixed to the backrest F13. That is, since the work management device 1 and the fork pockets 201 and 202 approach in the height direction, the work management device 1 can cause an irradiation angle (an angle in the height direction) of the laser light or the like to the fork pockets 201 and 202 to be further close to horizontal (perpendicular to the insertion surface).

It should be noted that the facing determination may be a determination as to whether or not the fork F101 and the fork F102 are perpendicular to the container 20 or the insertion surface 211.

Further, the spatial recognition sensor may perform spatial recognition using means other than the laser light. For example, the work management device 1 may perform spatial recognition using radio waves other than laser light, or may perform the spatial recognition using a captured image, for example. Examples of the spatial recognition sensor may include a monocular camera, a stereo camera, an infrared camera, a millimeter wave radar, an optical laser, a light detection and ranging or laser imaging detection and ranging (LiDAR), and an (ultra) sonic wave sensor.

Further, the work management device 1 may output the warning or the like when the fork pockets 201 and 202 are not located in the horizontal direction, that is, when the fork pockets 201 and 202 are misaligned in the vertical direction.

Further, the work management device 1 may be connected to an automatic driving device or may be a portion of the automatic driving device. That is, the work management device 1 may perform a misalignment determination and may automatically drive, the forklift F1 so that the forks are not be aligned. For example, when the forks are misaligned in a “height direction” as a result of the misalignment determination, the work management device 1 raises and lowers the fork F101 and the fork F102 to increase and decrease the height. For example, when the forks are misaligned in a “lateral direction” as a result of the misalignment determination, the work management device 1 adjusts a steering angle, a gear, an accelerator, and a brake so that the position of the forklift F1 is aligned in the lateral direction.

Further, the work management device 1 may exclude the road surface G, a wall, and an object at a position farther than a predetermined distance from the detection targets (sensing information). When projection onto each surface is performed, the work management device 1 excludes these from projection targets.

It should be noted that the work management device 1 may use edge detection when detecting the container 20, the loading platform L1, and the forks F101 and F102. Here, an edge detected using edge detection is, for example, the distance R or a place at which a rate of change thereof is large.

As a specific edge detection, the work management device 1 may use as an edge, a portion in which a partial differential on each coordinate axis is equal to or greater than a threshold value for the detected object. Further, for example, the work management device 1 may use, as an edge, a portion in which detected planes intersect, a portion in which a difference in distance R between adjacent or close points in the reverse direction is equal to or greater than a threshold value, or a portion adjacent to a portion in which reflected light of laser light is not detected, or a portion adjacent to a portion in which a reception level of the reflected light of the laser light is low. The work management device 1 may perform edge detection using another scheme.

It should be noted that the work management device 1 may perform the above process by recording a program for realizing each function in a computer-readable recording medium, loading the program recorded on the recording medium into the computer system, and executing the program. It should be noted that the “computer system” described herein includes an OS or hardware such as a peripheral device. Further, the “computer system” also includes a WWW system including a homepage providing environment (or display environment). Further, the “computer-readable recording medium” includes a storage device such as a flexible disk, a magneto-optical disc, a read only memory (ROM), a portable medium such as a CD-ROM, or a hard disk built in the computer system. Further, the “computer-readable recording medium” also includes a recording medium that holds a program for a certain time, such as a volatile memory (RAM) inside a computer system including a server and a client when a program is transmitted over a network such as the Internet or a communication line such as a telephone line.

Further, program may be transmitted from a computer system in which the program is stored in a storage device or the like to other computer systems via a transfer medium or by transfer waves in the transfer medium. Here, the “transfer medium” for transferring the program refers to a medium having a function of transferring information, such as a network (communication network) such as the Internet or a communication line such as a telephone line. Further, the program may be a program for realizing some of the above-described functions. Further, the program may be a program capable of realizing the above-described functions in combination with a program previously stored in the computer system, that is, a so-called differential file (differential program).

Priority is claimed on Japanese Patent Application No. 2017-56011, filed Mar. 22, 2017, the content of which is incorporated herein by reference.

### REFERENCE SYMBOLS

F1 Forklift

F101, F102 Fork

F11, F12 Fork rail

F13 Backrest

F14 Mast

20 Container

201, 202 Fork pocket

211 Insertion surface

1 Work management device

111 CPU

112 IF

113 Communication module

114 sensor

121 ROM

122 RAM

123 HDD

101 Sensor

102 Vehicle Information acquisition Unit

103 GNSS receiver

104 Analysis unit

105 Control unit

106 Output unit

107 Recording unit

108 Communication unit

1. A vehicle-mounted device comprising:
an analysis unit that detects an insertion target into which an insertion blade is inserted, on the basis of sensing information acquired from a spatial recognition device; and
a control unit that performs a misalignment determination to determine whether or not a positional relationship between an insertion portion of the insertion target and the insertion blade is aligned on the basis of the sensing information.

2. The vehicle-mounted device according to claim 1, wherein the control unit determines that the insertion blade is facing an insertion surface having the insertion portion on the basis of the sensing information, and then, performs the misalignment determination or a warning based on the misalignment determination.

3. The vehicle-mounted device according to claim 1, wherein the control unit performs the misalignment determination or a warning based on the misalignment determination on the basis of a timing at which the insertion blade is inserted into the insertion portion.

4. The vehicle-mounted device according to claim 1, wherein the control unit performs the misalignment determination or a warning based on the misalignment determination on the basis of a positional relationship between the insertion blade and the insertion portion.

5. The vehicle-mounted device according to claim 1, wherein the control unit changes a warning based on the misalignment determination on the basis of a timing at which the insertion blade is inserted into the insertion portion.

6. The vehicle-mounted device according to claim 1, wherein the control unit changes a warning based on the misalignment determination on the basis of a positional relationship between the insertion blade and the insertion portion.

7. A cargo handling machine comprising the vehicle-mounted device including:
an analysis unit that detects an insertion target into which an insertion blade is inserted, on the basis of sensing information acquired from a spatial recognition device; and
a control unit that performs a misalignment determination to determine whether or not a positional relationship between an insertion portion of the insertion target and the insertion blade is aligned on the basis of the sensing information.

8. A control circuit that determines whether or not a positional relationship between an insertion portion of an insertion target into which an insertion blade is inserted and the insertion blade is aligned, on the basis of sensing information acquired from a spatial recognition device.

9. A control method comprising:
detecting, by an analysis unit, an insertion target into which an insertion blade is inserted, on the basis of sensing information acquired from a spatial recognition device; and
performing, by a control unit, a misalignment determination to determine whether or not a positional relationship between an insertion portion of the insertion target and the insertion blade is aligned on the basis of the sensing information.

10. A non-transitory computer readable medium which stores a program causing a computer to:
detect an insertion target into which an insertion blade is inserted, on the basis of sensing information acquired from a spatial recognition device; and
perform a misalignment determination to determine whether or not a positional relationship between an insertion portion of the insertion target and the insertion blade is aligned on the basis of the sensing information.
